(19) United States
(12) Patent Application Publication
(10) Pub. No.: US 2007/0280328 A1
(43) Pub. Date: Dec. 6, 2007

(54) Melting method using graphite melting vessel

(75) Inventors: David S. Lee, Muskegon, MI (US); Russell G. Vogt, Yorktown, VA (US)

Correspondence Address: Mr. Edward J. Timmer, P.O. Box 770, Richland, MI, 49083-0770, US

(73) Assignee: Howmet Corporation

(21) Appl. No.: 11/804,018

(22) Filed: May 16, 2007

Related U.S. Application Data
(60) Provisional application No. 60/809,290, filed on May 30, 2006.

(51) Int. Cl. H05B 6/22

(52) U.S. Cl. 373/155

(57) ABSTRACT

Method of melting a metallic material such as a metal or or alloy involves the steps of disposing the metal or alloy in a crucible or other melting vessel having an induction coil disposed about an upstanding side wall of the vessel. The side wall comprises graphite and has a side wall thickness not exceeding about 0.50 inch. The induction coil is energized to generate an electromagnetic field effective to heat and melt the metal or alloy in the crucible and having a low enough frequency that the side wall is so transparent (does not suscept) to the electromagnetic field of the induction coil that a solid skull forms on the side wall to separate the melted metal or alloy from the side wall of the crucible.

This application claims benefits and priority of U.S. provisional application Ser. No. 60/809,290 filed May 30, 2006.

### FIELD OF THE INVENTION

The invention relates to a method for melting metallic materials, more particularly, to a method for induction melting metallic materials in a graphite melting vessel in a manner to improve castability and reduce contamination of the melt.

### BACKGROUND OF THE INVENTION

Titanium metal and alloys are currently melted by a number of cold hearth processes including vacuum arc remelting (VAR), induction skull remelting (ISR), plasma arc melting (PAM), and electron beam (EB) melting. The copper hearths or crucibles used in each of these processes are water cooled such that the molten titanium metal or alloy forms a thin solid layer known as a skull over the copper hearth or crucible. The skull prevents the molten titanium metal or alloy from attacking and melting the copper hearth or crucible and results in a low interstitital, chemically homogenous melt. U.S. Pat. No. 4,923,508 discloses a ceramicless induction skull melting crucible having a plurality of upstanding, water cooled metallic fingers that collectively form an upper metallic sleeve of the melting crucible and a water cooled metallic bottom. U.S. Pat. No. 6,214,286 discloses an induction melting crucible comprising a refractory or graphite sleeve residing on a water cooled base plate for melting titanium alloys.

Previously when titianum metal or alloys are melted in oxide crucibles, even those considered to be relatively inert, such as dense alumina or zirconia, the molten metal or alloy reacted with the oxide crucible to an extent that the molten metal or alloy picked up oxygen in unacceptable amounts that render an end product component cast from the molten metal or alloy extremely brittle and unusable.

Moreover, previously when titianum metal or alloys have been melted in graphite crucibles, the molten metal or alloy reacted with the graphite crucible to an extent that the molten metal or alloy picked up carbon from the crucible in unacceptable amounts.

### SUMMARY OF THE INVENTION

The present invention provides a method of induction melting a metallic material, such as a metal or alloy, in a graphite melting vessel, such as a graphite crucible, in a manner to reduce contamination of the melted metal or alloy by contact and/or reaction with the crucible.

In one illustrative embodiment of the invention, the method involves the steps of disposing the metal or alloy to be melted in a crucible having an induction coil disposed about an upstanding side wall of the crucible wherein the side wall comprises graphite and has a side wall thickness not exceeding about 0.50 inch and energizing the induction coil to generate an electromagnetic field effective to heat and melt the metal or alloy. The crucible can have a graphite or other bottom wall connected to the side wall. The induction coil is energized to generate an electromagnetic field effective to heat and melt the metal or alloy in the crucible and having a low enough frequency that the crucible side wall is substantially transparent (does not suscept) to the induction coil electromagnetic field that a solid skull forms on an inner surface of the side wall of the crucible to separate the melted metal or alloy from the side wall.

The crucible sidewall can be provided or formed in a variety of ways such as including, but not limited to, as a monolithic graphite sidewall sleeve that can be integral with a crucible bottom wall or separate from and connected to the bottom wall, as a thin graphite sheath or liner placed within an upstanding sidewall of a ceramic or refractory body or vessel, and/or as a graphite layer of an appropriate thickness formed by physical vapor deposition, graphite slurry impregnation, or other technique on an inner surface of an upstanding sidewall of a ceramic or refractory crucible body or vessel.

For certain metals or alloys such as titanium alloys or nickel or cobalt base superalloys, the crucible is disposed in a relative vacuum (subambient pressure) and/or a protective atmosphere (partial pressure of Ar) during melting of the metal or alloy.

In another illustrative embodiment of the invention, the thickness of the crucible side wall is about 0.03 inch to about 0.50 inch, while the frequency of the elecromagnetic field is in the range of about 0.3 kHz to about 6.0 kHz. The bottom wall can the same or different wall thickness.

The method can be practiced to provide a melted metal or alloy having a carbon content less than that provided by melting the same metal or alloy in a graphite crucible that suscepts to and is heated by the induction coil electromagnetic field. For purposes of illustration and not limitation, the method can be practiced to provide a melted titanium alloy having a carbon content of about 800 ppm by weight or less, preferably about 700 ppm by weight C or less, and even more preferably from 5 to 500 ppm by weight C.

The invention can be practiced to melt titanium base alloys, zirconium alloys, nickel or cobalt base superalloys, and other crucible-reactive metals or alloys in a manner to reduce contamination of the melt with interstitial elements, such as one or more of carbon or oxygen. The melted metal or alloy can be removed, for example, by pouring from the melting crucible, leaving the solid skull in place on the inner surface of the side wall of the crucible.

The above advantages of the invention will become more readily apparent to those skilled in the art from the following detailed description taken with the following drawings.

### BRIEF DESCRIPTION OF THE DRAWINGS

FIG. 1 is a cross-sectional view of induction melting apparatus for practicing a method embodiment of the invention.

FIG. 2 is a cross-sectional view of induction melting apparatus for practicing another method embodiment of the invention.

### DETAILED DESCRIPTION OF THE INVENTION

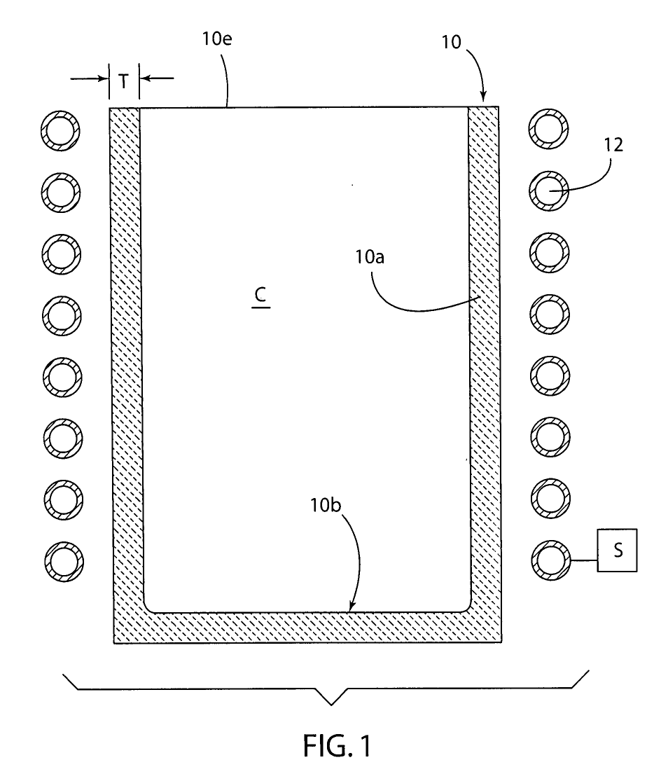

An illustrative method embodiment of the invention can be practiced using an induction melting apparatus of the type shown in FIG. 1 for melting a solid charge of a metallic material, which includes metals, metal alloys, intermetallic compounds, thioxtropic metallic materials, and other metallic materials. For purposes of illustration and not limitation of the invention, the method can be used to melt a solid charge that comprises a titanium base alloy, titanium base intermetallic compound, zirconium base alloy, nickel base superalloy, cobalt base superalloy, and any other metal or alloy. Illustrative titanium alloys, which can be melted, can include as metallic alloying elements one or more of Al, Mn, Nb, Cr, W, Fe, Mo, Ta or other metals and as non-metallic alloying elements one or more of Si, B, or other non-metallic elements as well as incidental impurities. Examples 1 and 2 set forth below describe particular illustrative Ti alloys that have been melted. A particular Ti alloy having a nominal composition, in atomic %, of 45% Al-2% Mn-2% Nb-balance Ti and incidental impurities, also was melted pursuant to the invention.

The solid charge can comprise a metal ingot, bar, or other solid stock or a prealloyed ingot, bar or other solid stock. Alternately, the solid charge can comprise appropriate proportions of respective elemental metallic constitiuents and/or non-metallic constituents of an alloy.

The melting apparatus includes a melting vessel such as a crucible 10 and induction coil 12 disposed about the crucible side wall 10a to inductively heat the solid charge and melt it. The induction coil 12 is connected to a power source S for energizing the induction coil as described below.

For certain metals or alloys such as titanium alloys, zirconium alloys, and nickel or cobalt base superalloys, the crucible 10 is disposed in a relative vacuum (subambient pressure) during melting. For example, the crucible or other melting vessel can be disposed in a vacuum heating furnace. However, the invention is not limited to melting in a vacuum since melting can be conducted in an inert atmosphere, in air, or in any other atmosphere depending upon the metal or alloy being melted.

In one illustrative embodiment of the invention, the crucible 10 includes an upstanding side wall 10a connected to or integral with a bottom wall 10b to form a cruicble chamber C. The side wall 10a includes an upper annular end 10e providing an opening through which a solid charge of metallic material can be introduced into the chamber C of the crucible. The crucible 10 is shown having an integral graphite bottom wall. However, the invention is not so limited and envisions a crucible having a side wall comprising graphite and a separate bottom wall comprising graphite or a different material, such as a ceramic material, connected to the side wall, for example, as disclosed in U.S. Pat. 6,214,286, the teachings of which are incorporated herein by reference.

In the illustrative embodiment, the crucible side wall 10a and bottom wall 10b comprise graphite. The graphite forming the side wall and bottom wall preferably is a dense graphite having a density of at least about 1.75 g/cm³, preferably in the range of 1.78 to 1.85 g/cm³. The invention is not limited to this particular density of graphite, however. Purity of the graphite side wall 10a of the crucible preferably is controlled to a high purity level to substantially avoid an unwanted reaction between the side wall and the melted metal or alloy before the soldified skull forms. Commercially available, high purity graphite can be used for the side wall.

The side wall 10a is shown forming a right cylinder, although the invention is not limited to any particular shape of the side wall 10a. The diameter and length dimensions of the side wall can be selected as needed for a particular melting application.

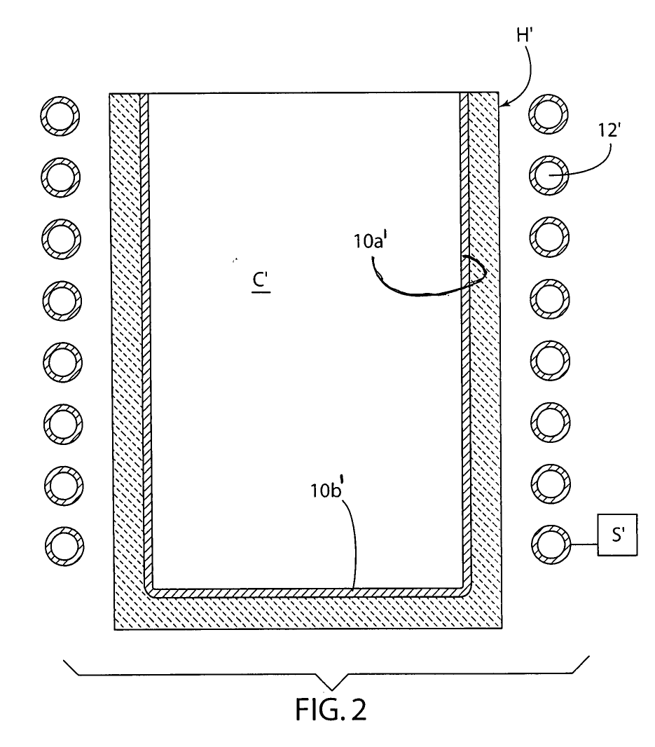

The invention envisions providing or forming the crucible sidewall 10a in a variety of ways such as including, but not limited to, as a monolithic graphite sidewall sleeve that can be integral with a crucible bottom wall 10b (FIG. 1) or separate from and connected to the bottom wall, as a thin graphite liner or sheath 10a′ placed within an upstanding sidewall of a ceramic or refractory crucible-like body or vessel (FIG. 2), and/or as a graphite layer of appropriate thickness formed by physical vapor deposition, graphite slurry impregnation, or other method on an inner surface of an upstanding sidewall and optionally on a bottom wall of a ceramic or refractory crucible-like body or vessel.

Melting of the metal or alloy pursuant to a method embodiment of the invention involves the combination of use of a crucible 10 having a sufficiently thin side wall thickness together with a low frequency induction coil electromagnetic field to render the crucible side wall effectively transparent to the electromagnetic field so as not to suscept thereto and thereby remain at a temperature where a solid skull of the metal or alloy being melted can form on the inner surface of the side wall 10a.

The wall thickness T of the side wall 10a is selected in dependence on the frequency of the electrical power supplied to the induction coil 12 so that side wall is substantially transparent (does not suscept) to the electromagnetic field of the induction coil. By substantially transparent is meant that the graphite side wall 10a does not substantially suscept to the induction coil field and thus is not substantially heated thereby so that the side wall, in effect, behaves as a “cold wall” crucible that permits a solid skull to form on an inner surface of the side wall 10a to separate the melted metal or alloy from the side wall during the melting operation.

In this way, contamination of the melted metal or alloy by contact and/or reaction with the crucible 10 is reduced. For example, pickup of interstitial elements, such as carbon and oxygen by the melted metal or alloy by contact and/or reaction with the crucible can be controlled and/or reduced. In melting titanium base alloys, the carbon content of the alloy after melting pursuant to the invention typically is about 800 ppm by weight or less C, preferably about 700 ppm by weight or less C, and even more preferably from 5 to 500 ppm by weight C.

The wall thickness of the bottom wall 10b can be the same as or different from that of the side wall 10a since the bottom wall typically is outside the influence of the induction coil 12 such that a solid skull typically does not form thereon during the melting operation, although a solid skull may form on the bottom wall in some situations depending upon the position of the induction coil. In the event the bottom wall 10b is disposed so as to suscept to the induction coil field, then the bottom wall thickness will be chosen in the same manner as the side wall thickness purusant to the invention so as to render the bottom wall 10b substantially transparent (does not suscept) to the electromagnetic field of the induction coil. The bottom wall thickness and type of bottom wall is a compromise between structual integrity so that the charge to be melted does not crack the crucible when the charge is placed therein and minimizing the amount the crucible bottom suscepts in the field.

The thickness of the side wall 10a typically does not exceed about 0.5 inch to this end when the induction coil elecromagnetic field is in the range of about 0.3 kHz to about 6.0 kHz. In a preferred embodiment of the method of the invention, the thickness of the crucible side wall 10a is about 0.03 inch to about 0.50 inch, while the frequency of the induction coil elecromagnetic field is in the range of about 0.3 kHz to about 2.0 kHz. The bottom wall 10b can have a thickness of 0.125 to 0.50 inch depending upon its location relative to the induction coil 12 and the frequency of the field.

In practice of an illustrative method embodiment of the invention, a solid charge of the metal or alloy to be melted, such as titanium alloy, is placed in the chamber C of the crucible 10 in a VIM or other melting furnace. The induction coil 12 then is energized at an electrical power level and low frequency for a time to melt the charge to a molten state wherein the combination of a sufficiently thin crucible side wall thickness together with a low frequency induction coil field renders the crucible side wall effectively transparent to the electromagnetic field of the induction coil so as not to suscept thereto and thereby remain at a temperature where a solid skull of the metal or alloy being melted can form on the inner surface of the side wall 10a of FIG. 1 with no skull typically being formed on the bottom wall 10b. For reactive metals and alloys such as superalloys and titanium and its alloys, the melting operation is conducted under a suitable vacuum or inert gas. A thin solidified lining or skull of the metal or alloy forms in-situ on the inner surface of the side wall 10a shortly after the charge reaches the molten state.

The lining or skull typically has a thickness in the range of 0.05 to 0.20 inch. Thereafter, the molten metal or alloy is confined or contained within the solidified metal or alloy skull until the molten charge is poured or otherwise removed from the crucible 10, for example, to a conventional mold (not shown). The solidified lining or skull remains in place on the inner surfaces of the side wall 10a. The crucible then can be reused in melting another solid charge of the metal or alloy.

A host of advantages accrue from practice of the invention. For example, the crucible is not degraded and bulk carbon pickup by the melted metal or alloy is controlled so as to maintain metal or alloy mechanical properties. The minimal contact between the melted metal or alloy and the crucible permits controlled superheat to be provided in the melt to provide more generous casting parameters for the particular metal or alloy. For example, the capability to provide extra superheat is especially advantageous in the melting and casting of titanium aluminide intermetallic alloys, such as gamma TiAl, which are notoriously difficult to cast into thin mold sections. The control of carbon pickup to minimize impact on alloy mechanical properties while providing the capability to fill thin mold sections as a result of controlled melt superheat is particularly advantageous for producing aerospace and automotive components including, but not limited to, gas turbine engine airfoils and turbocharger turbine wheels. Further, the method of the invention can be practiced using existing VIM (vacuum induction melting) furnace equipment instead of expensive cold hearth casting equipment, providing a substantial economic benefit.

The following examples are offered to further illustrate and not limit the invention.

### EXAMPLE I

Comparison melting trials of a common master heat of Ti-Al-Mn-Nb-B alloy were conducted. Each ingot weighed 12 pounds. One comparison melting trial involved melting the ingot using conventional induction skull remelting at a vacuum of less than 10 microns for about 10 minutes (designated ISR Crucible). Another comparison melting trial involved melting an ingot using conventional vacuum induction melting in an alumina (Al₂O₃) crucible at a vacuum of less than 10 microns for about 10 minutes (desginated Al2O3 Crucible). Another comparison melting trial involved melting the ingot using conventional vacuum induction melting in a thick-walled graphite cruible having a side wall thickness of 0.25 inches made of commercially available high purity graphite at a power supply frequency of 2.4 kHz and kilowatts of 60 kW at a vacuum of less than 10 microns for a time of about 10 minutes (designated Thickwall Graphite Crucible). The bottom crucible wall was integral to the side wall with the same thickness.

A melting trial pursuant to the invention was conducted in a thin wall graphite crucible having a side wall thickness of only 0.125 inch made of commercially available high purity graphite and density of 1.75 g/cm³ at a power supply frequency of 2.4 kHz and kilowatts of 60 kW at a vacuum of less than 10 microns for a time of about 10 minutes (designated Thinwall Graphite Crucible). The bottom crucible wall was integral to the side wall with a bottom wall thickness of 0.25 inch.

Another melting trial pursuant to the invention was conducted in a thin wall graphite crucible having a side wall thickness of only 0.125 inch made of commercially available high purity graphite and density of 1.75 g/cm³ at a power supply frequency of 1.0 kHz and kilowatts of 60 kW at a vacuum of less than 10 microns for a time of about 10 minutes (designated Thinwall Graphite Crucible+LF Power). The bottom crucible wall was integral to the side wall with a bottom wall thickness of 0.25 inch.

The Table below sets forth the results of the melting and casting trials. The nominal composition of the Ti-Al-Mn-Nb-B alloy in weight % is shown as Nominal Alloy at the top of the Table. The alloy compositions, all expressed in weight % or ppm by weight for O, N, H and C, after melting in each trail are shown below the Nominal Alloy composition.

TABLE

| | Ti | Al | Mn | Nb | B | O (ppm) | N (ppm) | H (ppm) | C (ppm) |
|---|---|---|---|---|---|---|---|---|---|
| Nominal Alloy | Bal | 30.6 | 3.3 | 4.7 | 0.29 | 800 | 180 | 20 | 100 |
| Typical ISR Crucible | Bal | 31.0 | 2.0 | 4.6 | 0.33 | 790 | 200 | 10 | 100 |
| Al2O3 Crucible | Bal | 30.8 | 3.1 | 4.8 | 0.33 | 8000 | 180 | 10 | 100 |
| Thickwall Graphite Crucible | Bal | 30.8 | 2.6 | 4.8 | 0.30 | 1060 | 120 | 10 | 1100 |
| Thinwall Graphite Crucible | Bal | 31.5 | 2.7 | 4.9 | 0.29 | 840 | 90 | 10 | 800 |
| Thinwall Graphite Crucible + LF Power | Bal | 30.2 | 3.0 | 4.7 | 0.29 | 1040 | 170 | 10 | 300 |

As seen from the Table, no interstitial elements are picked up by the alloy in typcial ISR melting/casting. However, ISR melting suffers from low alloy superheat, which adversely affects castability of the alloy. The alloy picked up so much oxygen when melted in the Al₂O₃ crucible that the alloy was completely brittle and did not survive the casting process into a mold. The Thickwall Graphite Crucible melting trial operated at 2.4 kH provided good superheat for castability and full-filling of castings, but the carbon pickup of the alloy was much greater than allowable, embrittling the alloy. The Thinwall Graphite Crucible melting trial purusant to an embodiment of the invention operated at a frequency 2.4 kH reduced carbon pickup by the alloy. The Thinwall Graphite Crucible+LF Power melting trial purusant to an embodiment of the invention operated at a frequency 1.0 kH further reduced carbon pickup by the alloy with very well controlled carbon pick up, well within reasonable limits so as not to adversely affect alloy mechanical properties.

### EXAMPLE II

Additional melting trials with an ingot of an alloy having a nominal composition, in weight %, of 30.7% Al-2.1% Mn-4.8%-Nb-0.32 B-balance Ti, were conducted to further characterize the relationship of side wall thickness and the induction coil frequency needed to render the crucible side wall substantially transparent (does not suscept) to the electromagnetic field of the induction coil so that a solid skull forms thereon during melting.

To this end, melting trials were conducted using different combinations of crucible side wall thickness and induction coil frequency as shown below:
1) 2.4 kHz/0.25 inch crucible graphite wall—did not provide cold wall effect
2) 2.4 kHz/0.030 inch crucible graphite wall—did provide cold wall effect*
3) 2.4 kHz/0.125 inch crucible graphite wall—did provide cold wall effect
4) 1.0 kHz/0.125 inch crucible graphite wall—did provide cold wall effect

The crucibles for melting trials 1), 3) and 4) were solid, dense (1.75 g/cm³), commercially available high purity graphite having inner diameter (ID) and length dimensions of 5.25 inches and 11 inches, respectively, and a wall thickness dimension shown above for containing the titanium alloy melt. The melting trials 3) and 4) pursuant to the invention demonstrated the aforementioned cold wall effect. The melting trial 1) outside the invention did not demonstrate the cold wall effect.

Trial 2) designated with an asterisk above used a commercially available Grafoil™ side wall sheath 10a′ of 0.030 inch thickness residing in a cylindrical bore of a ceramic (e.g. alumina) crucible H′ with the induction coil 12′ disposed about the periphery of the crucible. The sheath was closed at the bottom by a Grafoil bottom wall layer 10b′ having a thickness of 0.030 inch. The Grafoil sheath was not pure graphite and had a inner diameter of 5.25 inches and length of 11 inches. FIG. 2 illustrates the experimental set up where like reference numerals primed represent like features of FIG. 1.

During melting, the Grafoil sheath reacted with the titanium alloy before the solid skull could form because the sheath was not pure graphite. As a result of the reaction, the alloy included 3780 ppm O, 10 ppm N, 10 ppm H, and 5200 ppm C. The reaction led to a breach of the sheath and lack of containment of the molten titanium alloy. However, the Grafoil sheath did exhibit the aforementioned cold wall effect.

Although the invention has been described hereinabove in terms of specific embodiments thereof, it is not intended to be limited thereto but rather only to the extent set forth hereafter in the appended claims.

We claim:

1. Method of melting a metallic material, comprising disposing metallic material to be melted in a melting vessel having an induction coil disposed about an upstanding side wall thereof, said side wall comprising graphite and having a side wall thickness not exceeding about 0.50 inch, and energizing the induction coil to generate an electromagnetic field effective to heat and melt the material and having a low enough frequency that the side wall is so transparent to the electromagnetic field of the induction coil that a skull forms on the side wall to separate the melted material from the side wall.

2. The method of claim 1 wherein the side wall thickness is about 0.03 inch to about 0.50 inch.

3. The method of claim 1 wherein the frequency is in the range of about 0.3 kHz to about 6.0 kHz.

4. The method of claim 1 including providing a subambient pressure during melting.

5. The method of claim 1 wherein the graphite comprises dense graphite having a density of at least about 1.75 g/cm³.

6. The method of claim 5 wherein the density is in the range of 1.78 to 1.85 g/cm³.

7. The method of claim 1 wherein the metallic material comprises a first metal and at least one of a second metal or a non-metallic element.

8. The method of claim 1 wherein the metallic material comprises titanium and another element as an alloy or as elemental constituents of the alloy.

9. The method of claim 8 wherein carbon content of the melted alloy is about 800 ppm by weight or less.

10. The method of claim 9 wherein the carbon content of the melted alloy is 700 ppm by weight or less.

11. The method of claim 10 wherein the carbon content of the melted alloy is 5 to 500 ppm by weight.

12. The method of claim 1 wherein the metallic material comprises zirconium or a zirconium alloy.

13. The method of claim 1 wherein the melting vessel comprises a crucible having a side wall and a bottom wall integral with or connected to the side wall, said bottom wall and said side wall comprising graphite.

14. The method of claim 1 wherein the side wall comprises an upstanding sleeve comprising graphite.

15. The method of claim 13 wherein the melting vessel includes a separate bottom wall closing off a lower end of the upstanding sleeve.

16. Method of melting an alloy of titanium and another element, comprising disposing the alloy in a crucible having an induction coil disposed about an upstanding side wall of the crucible, said side wall comprising graphite and having a side wall thickness of about 0.03 inch to about 0.50 inch, and energizing the induction coil to generate an electromagnetic field effective to heat and melt the alloy in the crucible and having a low enough frequency that the crucible side wall is substantially transparent to the electromagnetic field of the induction coil that a skull of solidfied alloy forms on the side wall.

17. The method of claim 16 wherein carbon content of the melted alloy is about 800 ppm by weight or less.

18. The method of claim 17 wherein the carbon content of the melted alloy is 700 ppm by weight or less.

19. The method of claim 18 wherein the carbon content of the melted alloy is 5 to 500 ppm by weight.

20. The method of claim 16 wherein said another element comprises a metal.

21. The method of claim 20 wherein the metal comprises one or more of Al, Mn, Nb, Cr, W, Fe, Mo, or Ta.

22. The method of claim 16 wherein said another element includes a non-metallic element.

23. The method of claim 22 wherein the non-metallic element comprises Si or B.

24. The method of claim 16 wherein the crucible includes a bottom wall closing off a lower end of the side wall, said bottom wall and said side wall comprising graphite.
